(19) United States
(12) Patent Application Publication
(10) Pub. No.: US 2010/0294850 A1
(43) Pub. Date: Nov. 25, 2010

(54) DISPENSING APPARATUS

(75) Inventor: David Bowen, West Yorkshire (GB)

Correspondence Address: CLARK & ELBING LLP, 101 FEDERAL STREET, BOSTON, MA, 02110, US

(73) Assignee: Logicor Limited, Wakefield (GB)

(21) Appl. No.: 12/677,937

(22) PCT Filed: Sep. 11, 2008
(86) PCT No.: PCT/GB2008/003078

§ 371 Date: Jun. 7, 2010

(30) Foreign Application Priority Data
Sep. 14, 2007 (GB) 0717918.7

(51) Int. Cl. B05B 7/04

(52) U.S. Cl. 239/1; 239/398

(57) ABSTRACT

Dispensing apparatus (16) is provided including a housing (18) having at least first and second fluid outlet means (30,32) to allow fluid to flow out of said dispensing apparatus. Channel means (23) are provided in the housing (18) least one aperture defined therein to allow fluid to flow from said channel means (23) through either of said at least first fluid outlet means (30, 32). The apparatus further includes fluid flow control means (104) for allowing selective control of the fluid flow from said channel means through said at least first or second fluid outlet means (30, 32). The fluid flow control means (104) includes a closure element (104) having passage means defined therein. The closure element is arranged to move relative to said channel means and/or said first and second fluid outlet means between a first position, wherein the passage means allows fluid communication between the at least one aperture of the channel means and the first fluid outlet means (32) to allow fluid flow therethrough, and a second position, wherein the passage means allows fluid communication between the at least one aperture of the channel means and the second fluid outlet means (32) to allow fluid flow therethrough.

This invention relates to dispensing apparatus, and particularly, although not necessarily exclusively to an improved dispensing apparatus for use with toilet apparatus, and to a method of using dispensing apparatus.

Although the following description refers almost exclusively to dispensing apparatus used for dispensing a fluid, such as water or a cleaning fluid for cleaning conventional toilet apparatus having a toilet bowl and toilet cistern associated therewith, it will be appreciated by persons skilled in the art that the toilet apparatus of the present invention could be used with any type of toilet or bathroom apparatus, such as a urinal, bidet, non-conventional toilet and/or the like and the dispensing apparatus could be used for any other suitable application.

A conventional toilet typically includes a toilet bowl with a toilet lid and/or seat associated with an upper surface thereof to allow a user to sit comfortably on the same in use. A cistern is connected to the toilet bowl to allow water contained in the cistern to flow into the toilet bowl following a user actuated flush to clear the toilet bowl after use. Clearance of the toilet bowl using the flushing water takes place via a siphon mechanism. The water typically enters the toilet bowl from the cistern at the same place or places after a toilet flush. The flow of water over the interior surface of the toilet bowl following a flush does provide a certain level of cleaning of the interior surface of the toilet bowl. However, most flush systems allow the flow of flushing water over a fixed part only of the toilet bowl and so there is normally at least part of the toilet bowl which is not cleaned after flushing. Furthermore, the water entering the toilet bowl from the cistern may not be of sufficient pressure or quantity to provide an adequate cleaning effect.

In order to overcome the abovementioned problem, it is known to provide a toilet brush in a bathroom or toilet environment to allow a user to specifically clean part or parts of an interior surface of a toilet bowl after use. The toilet brush is typically located in a container adjacent the toilet when not in use and has a handle attached to the brush to allow a user to manipulate the same. However, a problem with toilet brushes is that they are unhygienic, often produce drips on the toilet or surfaces surrounding the toilet in use, they are not aesthetically pleasing and often can look unsightly after use.

The applicant's co-pending International Patent Application WO2008/068447 discloses toilet cleaning apparatus in the form of a water dispenser. The dispenser includes an elongate body portion having a first end with first and second fluid outlet means for allowing the dispensing of water therefrom, a second end including fluid inlet means connected to a water conduit and user actuated control means provided on the body portion for controlling the flow of water through the dispenser. The first and second fluid outlet means include a central nozzle and a plurality of peripheral nozzles. The control means allows selective dispensing of fluid from either the central nozzle or the peripheral nozzles.

The elongate body portion is provided in two parts; a base part and a top part. A flow control valve is provided in the base part and a pressure valve is provided in the top part. Operation of the valves is achieved through rotation of the parts relative to each other. The pressure valve includes a valve housing which is slidably mounted in a channel defined in the top part of the body portion. First and second apertures are provided a spaced distance apart along the longitudinal axis of the valve housing. A valve seat is provided on an interior surface of the top part and the two apertures are movable relative to the valve seat between open and closed positions. With the first aperture in an open position, the second aperture engages with the valve seat and is closed and fluid can be dispensed from the central nozzle outlet. With the second aperture in an open position, the first aperture engages with the valve seat and is closed and fluid can be dispensed from the peripheral nozzle outlets.

It is an aim of the present invention to provide alternative dispensing apparatus.

It is a further aim of the present invention to provide alternative dispensing apparatus for use with toilet apparatus.

It is a yet further aim of the present invention to provide an improved fluid flow control means for use with dispensing apparatus.

It is a yet further aim of the present invention or provide a method of using dispensing apparatus.

According to a first aspect of the present invention there is provided dispensing apparatus, said dispensing apparatus including a housing having at least first and second fluid outlet means to allow fluid to flow out of said dispensing apparatus, channel means provided in said housing and having at least one aperture defined therein to allow fluid to flow from said channel means through either of said at least first and second fluid outlet means, said apparatus further including fluid flow control means for allowing selective control of the fluid flow from said channel means through said at least first or second fluid outlet means, characterized in that said fluid flow control means includes a closure element having passage means defined therein and said closure element is arranged to move relative to said channel means and/or said first and second fluid outlet means between a first position, wherein the passage means allows fluid communication between the at least one aperture of the channel means and the first fluid outlet means to allow fluid flow therethrough, and a second position, wherein the passage means allows fluid communication between the at least one aperture of the channel means and the second fluid outlet means to allow fluid flow therethrough.

The above arrangement has the advantage that less movement of the closure element is required to change which of the first or second fluid outlet means the fluid is dispensed from. As such, a user is required to provide a reduced actuation force on the dispensing apparatus to change the fluid flow therefrom. Thus, the pressure of the fluid flow from the dispensing apparatus can be adjusted more easily than prior art valve devices.

Although the term “dispensing apparatus” is used herein, it will be appreciated by persons skilled in the art that this term can be used to describe a small part of a larger dispensing apparatus, a valve mechanism, a fluid flow control mechanism, a pressure control mechanism and/or the like.

Preferably the closure element includes at least first and second passage means. The first passage means allows fluid communication between the at least one aperture of the channel means and the first fluid outlet means in the first position and the second passage means allows fluid communication between the at least one aperture of the channel means and the second fluid outlet means in the second position. Movement of the closure element relative to the channel means and/or the first and second outlet means, changes the alignment of the first and second passage means with the at least one aperture defined in the channel means and/or the outlet means.

Preferably when either passage means is substantially aligned with the at least one aperture defined in the channel means, fluid is capable of flowing from the channel means, through said aperture and into said passage means.

Preferably when the closure element is in the first position, fluid flow through the second fluid outlet means is substantially prevented. When the closure element is in the second position, fluid flow through the first fluid outlet means is substantially prevented. Thus, fluid flows through either the first or the second fluid outlet means but in a preferred embodiment does not flow through both fluid outlet means simultaneously. This allows the pressure of the fluid flow from the device to be adjusted.

In one embodiment the channel means includes a body element with a channel defined therein. The body element is preferably a separate component located in an interior of the housing of the dispensing apparatus (i.e. within a channel or cavity defined in the housing). The body element is typically an elongate element and the at least one aperture is typically defined in a side wall of the body element, such as for example along the longitudinal axis of the body element. The at least one aperture preferably allows fluid to pass from the channel of the body element transversally out of the body element and into the first and/or second passage means.

It is to be noted that fluid can be stored in the channel of the channel means and can flow out of said at least one aperture when the dispensing apparatus is actuated, or fluid can flow along the channel of the channel means from a fluid inlet associated with the dispensing apparatus and flow out of said at least one aperture when the dispensing apparatus is actuated.

The closure element is preferably in the form of an outer sleeve which is located around the external surface of the channel means or body element in the housing. The closure element is movable relative to the external surface of the channel means. Thus, in one embodiment the dispensing apparatus includes a housing with at least one cavity defined therein, a body element located in said cavity and an outer sleeve located around said body element within said cavity. The outer sleeve can move relative to an interior surface of the apparatus housing and an external surface of the channel means.

In one embodiment the channel defined in the body element includes a first channel portion and a second channel portion. Partition means separate the first and second channel portions from each other to prevent direct fluid flow between said first and second channel portions in normal use of the apparatus. The first and second channel portions are typically arranged in an end to end manner along the longitudinal axis of the channel means.

Preferably at least one aperture is defined in the first channel portion and at least one further aperture is defined in the second channel portion. The passage means of the closure element, and preferably the second passage means, allows fluid flow between the first and second apertures of the first and second channel portions in the second position. Thus, with the closure element in the second position, fluid is able to flow out of the first channel portion, through the first aperture into the second passage of the closure element, and then back into the second channel portion via the second aperture and out of the second fluid outlet means. The second fluid outlet means are preferably in fluid communication with the second channel portion.

The aperture of the second channel portion is typically a spaced distance apart along the longitudinal axis of the channel means from the aperture of the first channel portion.

Preferably the at least one aperture in the first channel portion includes two or more apertures. Preferably the at least one aperture in the second channel portion includes two or more apertures. The plurality of apertures within each channel portion is typically defined at a similar distance in the side walls of the channel means along the longitudinal axis thereof. A plurality of first and second passage means can be provided to allow fluid communication between the plurality of apertures and the fluid outlet means.

Preferably the first passage means is in the form of a channel arranged substantially transversally to the longitudinal axis of the closure element. Preferably the second passage means is in the form of a channel or recess arranged substantially parallel to the longitudinal axis of the closure element.

Thus, the at least second passage means communicates with both the at least first and second apertures in the second position, thereby allowing fluid to flow from the channel means on one side of the partition means, through the at least first aperture, through the second passage means, through the at least second aperture and back into the channel means on the other side of the partition means. The channel means on the other side of the partition means communicates with the at least second fluid outlet means.

Preferably the closure element is rotatably movable between the first and second positions. However, it will be appreciated that the closure element could be slidably movable between the first and second positions. Further preferably the closure element is rotatably movable relative to a part of the dispensing apparatus housing and/or the channel means.

In one embodiment the outer surface of the closure element is provided with a screw thread arrangement which movably engages with a complementary screw thread arrangement provided on an inner surface of the housing of the apparatus. A user typically rotates or twists a first part of the apparatus housing relative to a second part of the apparatus housing to actuate movement of the closure element between the first and second positions.

In an alternative embodiment a pin provided on one of the closure element or inner wall of the housing could be located in an angled or curved slot provided on the other of the closure element or inner wall of the housing to allow relative movement between said closure element and said housing.

Preferably the first fluid outlet means are arranged adjacent the peripheral edge of an end of the dispensing apparatus housing. In a preferred embodiment the first fluid outlet means includes a plurality of nozzles arranged around the peripheral edge to allow dispensing of water therefrom. The second fluid outlet means are preferably arranged substantially centrally of the end of the dispensing apparatus housing and of said first fluid outlet means. In a preferred embodiment the second fluid outlet means includes a single nozzle. The plurality of peripheral nozzles allows water to be dispensed at a different pressure to the single central nozzle.

The first and second fluid outlet means are typically in the form of elongate channels defined substantially parallel to the longitudinal axis of the apparatus housing with a first open end which communicates with the passage means of the closure element and a second open end defined in an external surface of the housing of the apparatus.

Sealing means can be provided on the closure element, the outer surface of the channel and/or the inner surface of the apparatus housing to prevent fluid flow beyond the above described paths. For example, the sealing means can be provided between the first and second apertures of the channel means and/or between the first and/or second passage means.

According to a yet further aspect of the present invention there is provided a method of using dispensing apparatus, said dispensing apparatus including a housing having at least first and second fluid outlet means to allow fluid to flow out of said dispensing apparatus, channel means provided in said housing and having at least one aperture defined therein to allow fluid to flow from said channel means through either of said at least first and second fluid outlet means, said apparatus further including fluid flow control means for allowing selective control of the fluid flow from said channel means through said at least first or second fluid outlet means, said fluid flow control means including a closure element having passage means defined therein and said method includes the step of moving the closure element relative to said channel means and/or said first and second fluid outlet means between a first position, wherein the passage means allows fluid communication between the at least one aperture of the channel means and the first fluid outlet means to allow fluid flow therethrough, and a second position, wherein the passage means allows fluid communication between the at least one aperture of the channel means and the second fluid outlet means to allow fluid flow therethrough.

Preferably the dispensing apparatus forms part of toilet cleaning apparatus. The dispensing apparatus dispenses fluid for cleaning a toilet. Connection means can be provided on the dispensing apparatus for connecting the same to a fluid supply for providing a source of fluid to the dispensing apparatus in use. The housing of the dispensing apparatus can include fluid inlet means and said at least first and second fluid outlet means.

The dispensing apparatus housing can include two or more parts and said parts can be rotatably mounted to each other in use. Rotation of the parts can allows actuation of the flow of fluid through the apparatus and/or control of the pressure of fluid dispensed from the apparatus.

Preferably the toilet includes at least a toilet bowl and the toilet cleaning apparatus is preferably used for cleaning said toilet bowl.

Preferably the dispensing apparatus is movable relative to the toilet bowl in use. This allows fluid to be dispensed in a user selected arbitrary direction and/or at a user selected arbitrary location to allow specific and targeted cleaning of the toilet bowl using dispensed fluid.

The toilet bowl can include or comprise any suitable bathroom receptacle, such as a conventional toilet bowl, bidet, urinal and/or the like.

Preferably the toilet includes flush means for allowing flushing of the toilet bowl in use. Operation and/or use of the dispensing apparatus is typically a separate and independent operation to the flush means.

In one embodiment the flush means includes a fluid reservoir, such as a toilet cistern, in communication with the toilet bowl and, on actuation of a flush in use, fluid from the fluid reservoir or toilet cistern can flow into the toilet bowl at one or more fixed or pre-determined positions.

Preferably the fluid reservoir or toilet cistern receives fluid from fluid conduit means. The connection means of the dispensing apparatus can be associated with the fluid conduit means to allow the fluid source for use with the toilet cistern in use to also be used as the fluid source for the dispensing apparatus.

Preferably the fluid is water and in one embodiment the water is supplied from a mains water supply.

The fluid dispensing means can receive fluid from any suitable source which can be separate to or associated with the fluid in the fluid reservoir. Thus, for example, the fluid dispensing means can receive fluid directly from a mains water supply. Alternatively, the fluid dispensing means can receive fluid from the toilet cistern, fluid reservoir, fluid conduit means and/or independent fluid source.

Preferably the dispensing apparatus is provided with a substantially flexible conduit or hose between said connection means and the fluid inlet means of said dispensing housing, thereby allowing the dispensing apparatus to be easily moved relative to said toilet bowl and/or said fluid supply.

Preferably the fluid conduit or hose is of such a length and/or dimensions to allow the dispensing apparatus to be moved between a storage position, a spaced distance apart from the interior surface of said toilet bowl, and an “in-use” position, in or adjacent the interior surface of said toilet bowl.

Support or holder means can be provided for supporting the dispensing apparatus in the storage position adjacent to or in proximity to the toilet apparatus when not in use.

Preferably the two or more parts of said dispensing housing are provided with complementary screw threaded portions to allow said parts to be rotatably mounted to each other. Other attachment means could be provided between two or more parts of said dispensing housing if required. These attachment means can include any suitable attachment, such as one or more screws, clips, nuts and bolts, adhesive, ties and/or the like.

Preferably said two or more housing parts are detachably attached to each other to allow the housing to be disassembled, cleaned and/or repaired. At least one complete revolution or rotation of said housing parts can be used to separate two or more parts of said housing in one example.

Preferably control means are associated with the dispensing apparatus to allow said apparatus to be moved between an “on” condition, wherein fluid can be dispensed therefrom, and an “off” condition, wherein fluid is prevented from being dispensed. In addition to or alternatively, the control means can be used to adjust the volume and/or pressure of the fluid being dispensed from said dispensing apparatus.

The control means preferably includes a valve arrangement. The valve arrangement can be controlled via any suitable means such as manually, electrically, pneumatically, hydraulically, mechanically and/or the like.

User actuation means can be associated with the control means to allow user actuation of said valve arrangement. The user actuation means can include any or any combination of one or more dials, handles, buttons, switches, knobs and/or the like. The user actuation means can be used to actuate movement of the closure element if required.

In a preferred embodiment the user actuation means and/or control means is associated with one or more of the rotatably mounted housing parts. At least partial rotation of at least one of said housing parts relative to an adjacent part typically actuates the control means, said user actuation means and/or movement of said closure element.

The control means can be provided on or associated with the dispensing apparatus, on the fluid conduit, mains water supply and/or the like.

The same or further control means can be provided on or associated with the dispensing apparatus for controlling the volume, pressure, temperature, direction and/or the like of the fluid being dispensed therefrom.

Preferably the first and/or second outlet means includes one or more fluid jets or nozzles.

Preferably at least two different types of fluid nozzles or jets are provided on the dispensing apparatus, the different fluid nozzles dispensing fluids at different pressure, volumes, spray patterns, temperature and/or the like.

Preferably the fluid outlet means are defined in one of said apparatus housing parts and further preferably the outlet means are defined in an upper housing part.

Preferably the fluid inlet means are defined in one of said housing parts and further preferably the inlet means are defined in a lower housing part.

At least one channel is defined in the housing of the dispensing apparatus to allow fluid to pass from said fluid inlet means to said first or said second fluid outlet means. Preferably a channel is defined in each of the housing parts and each of said channels is in fluid communication when said housing parts are joined together.

Preferably the apparatus housing is substantially elongate in form, such as for example a cylindrical rod, and the at least one channel runs substantially parallel to the longitudinal axis of said housing.

Preferably at least one compartment is defined in said apparatus housing. Further preferably access to said compartment is provided by separating two or more parts of said housing, such as by unscrewing the screw threads and/or the like. The housing channel is typically in communication with said compartment.

Preferably a cleaning product, medium or suitable substance is located between said parts, in said compartment and/or in said channel in use to allow a cleaning product or suitable substance to be released from the dispensing means in use. Alternatively, or in addition, a cleaning product or suitable substance can be provided in or associated with the fluid conduit means, fluid source and/or the like.

The fluid being dispensed from the dispensing apparatus preferably flows past or through the cleaning product or suitable substance in use to allow at least a part of said cleaning product or substance to be mixed, dissolved or contained in the fluid.

Location means can be provided to maintain the position of the cleaning product, medium or substance in a required position in said dispensing means, compartment and/or channel. The location means can include one or more ribs, flanges, clips and/or the like.

Preferably the cleaning product or suitable substance includes a cartridge or carrier in or on which the cleaning product or suitable substance is supported in use.

The cleaning product or substance can be provided or sold separately to the dispensing apparatus or as a part thereof. The cleaning product or substance is preferably at least partially soluble in water/fluid. Further preferably the product or substance colours the fluid/water when it is at least partially dissolved therein so that a user can determine when the product or substance is present.

Gripping means can be provided on an external surface of said dispensing apparatus to allow a user to grip the same in use. The gripping means can include a high friction surface, one or more protrusions protruding outwardly from said surface, a knurled surface and/or the like.

Preferably the gripping means are provided on one or more external surfaces of the housing parts associated with the control means and/or user actuation means.

The sealing means are provided to ensure that fluid is directed in the correct direction through the dispensing apparatus and/or to prevent fluid flow to certain areas of the dispensing apparatus. The sealing means can include one or more sealing washers and/or the like.

In one embodiment the housing includes at least three detachably attached parts, a first part with fluid outlet means associated therewith, a second part with fluid inlet means associated therewith and an intermediate part provided between said first and second parts. The cleaning medium can be provided in said intermediate part or any other part as required.

In a preferred embodiment the fluid flow control means is provided in said first part and the fluid inlet control means is provided in said second part.

Different dispensing heads can be provided with the housing. Thus, for example, the fluid outlet means can be defined in a housing part that can be interchanged with different housing parts having different arrangements of fluid outlet means. This allows different spray patterns of fluid to be provided. The fluid outlet means can be defined on a substantially planar or flat surface of said housing part in one embodiment, such that fluid is dispensed from substantially the same direction and/or height from said dispensing apparatus.

A housing part can be provide which is substantially U or J-shaped and the first and second fluid outlet means are defined in said U or J shaped portion. The U or J shaped portion allows fluid to be dispensed under a rim of the toilet bowl if required.

According to a further aspect of the present invention there is provided toilet cleaning apparatus including dispensing apparatus.

According to a yet further aspect of the present invention there is provided a method of using toilet cleaning apparatus, said apparatus including dispensing apparatus for dispensing fluid therefrom for cleaning said toilet and connection means for connecting said dispensing means to a fluid supply for providing a source of fluid to the dispensing apparatus in use, said dispensing apparatus including a housing having fluid inlet means and first and second fluid outlet means, and wherein said housing includes two or more parts and said parts are rotatably mounted to each other in use, said method including the steps of directing the first or second fluid outlet means of the dispensing means towards the interior of a toilet bowl and actuating the dispensing apparatus to allow fluid to flow at a suitable location in said toilet bowl.

According to a further aspect of the present invention there is provided fluid flow control means for dispensing apparatus.

It will be appreciated that the present invention is easy to use, is aesthetically pleasing and is hygienic compared to conventional cleaning methods. The dispensing apparatus can be used in addition to or as an alternative to a conventional toilet flush or toilet brush. The fluid dispensing apparatus can be retrofitted to any existing toilet apparatus.

The dispensing apparatus can also be used as an air-freshener by incorporating a pleasant odour containing component in the device. Disinfectant and/or anti-lime scale compositions can also be contained in the dispensing means if required.

Embodiments of the present invention will now be described with reference to the accompanying figures, wherein:

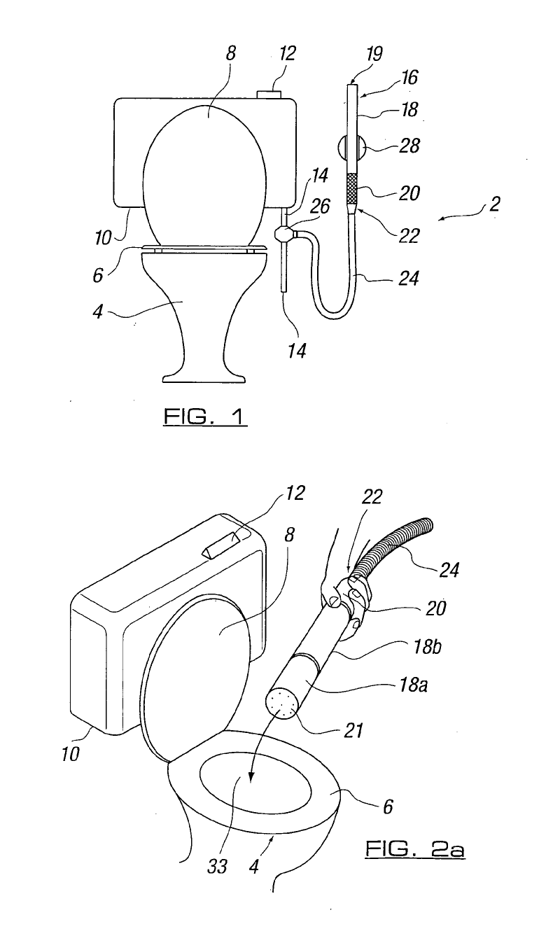

FIG. 1 is a front view of toilet apparatus according to an embodiment of the present invention in an “out-of-use” position;

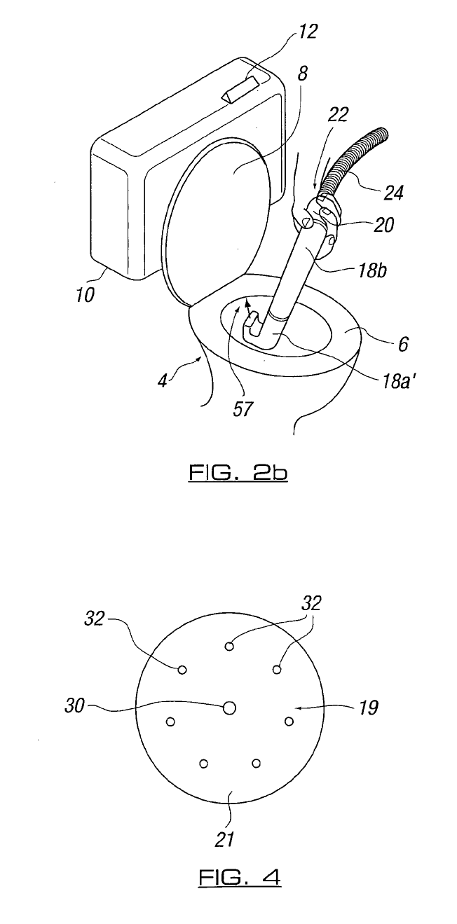

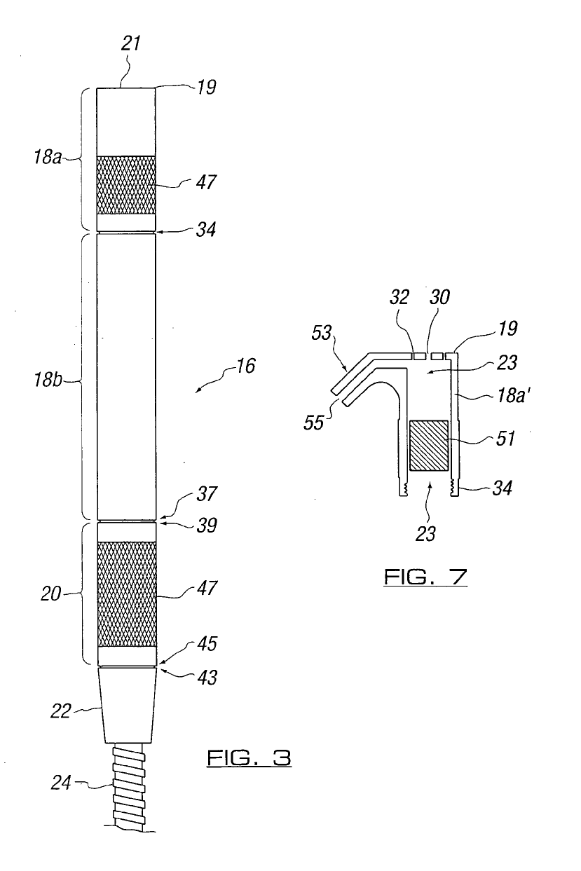

FIGS. 2a and 2b show perspective views of toilet apparatus with parts of the dispensing apparatus shown in FIG. 4 and FIG. 7 respectively in an “in-use” position;

FIG. 3 is a detailed external view of the dispensing apparatus in FIG. 1;

FIG. 4 is a plan view of a dispensing end of the dispensing apparatus in FIG. 3 showing the first and second fluid outlet means;

FIG. 5 is a cross sectional simplified view taken through the dispensing apparatus in FIG. 3;

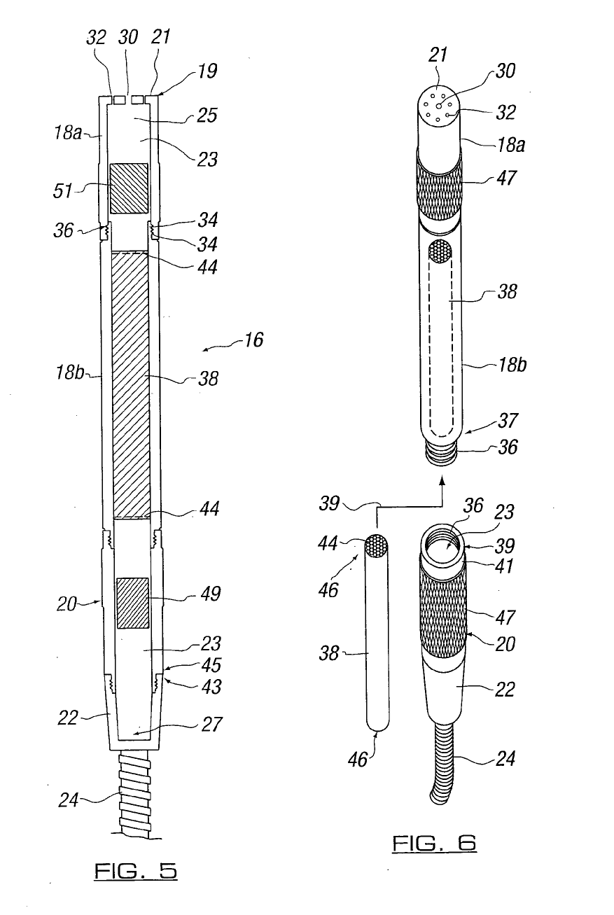

FIG. 6 shows a partially exploded simplified view of the dispensing apparatus in FIG. 3;

FIG. 7 is a cross sectional view taken through part of a dispensing head according to a further embodiment of the present invention;

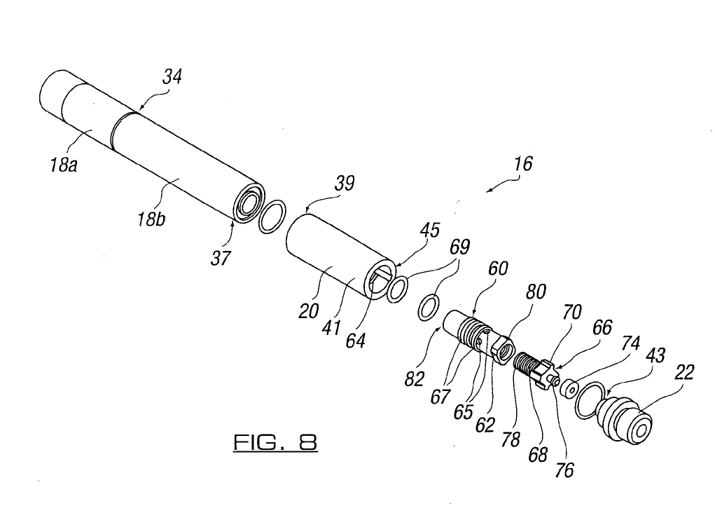

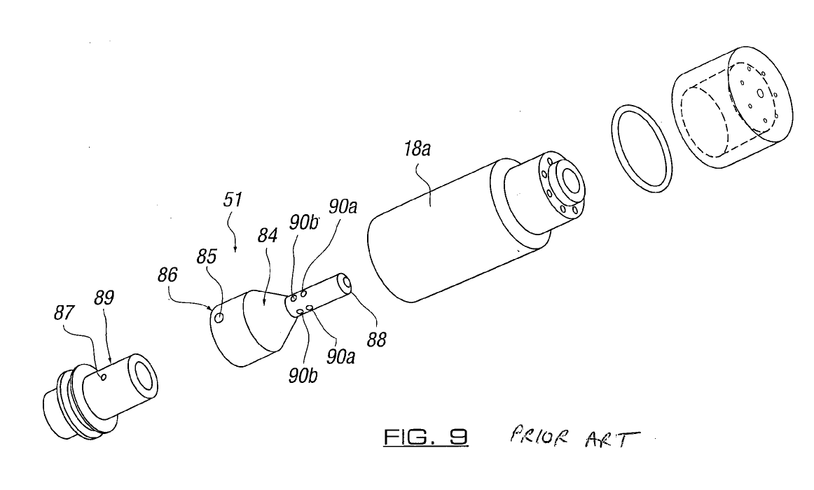

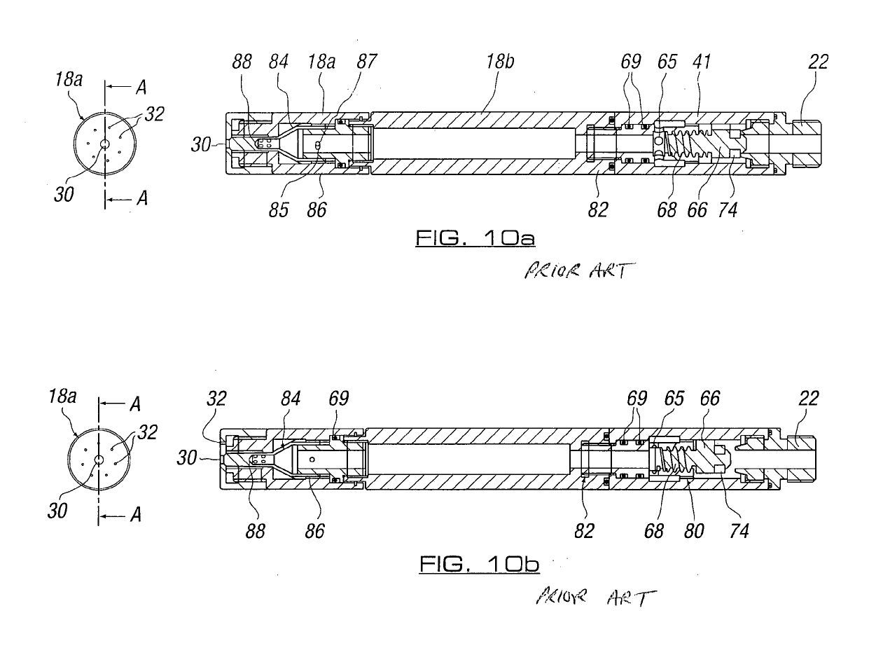

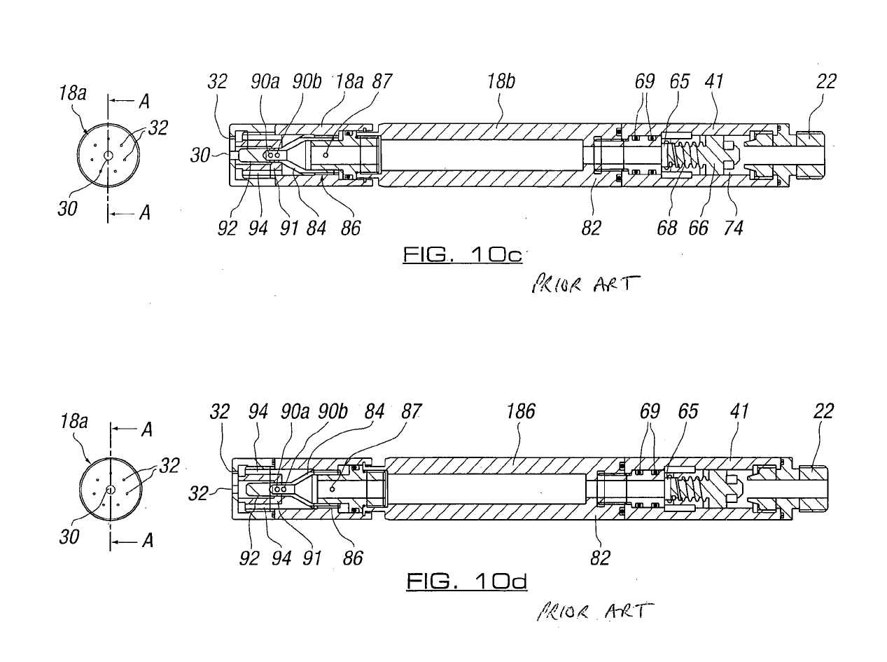

FIGS. 8 and 9 show exploded views of dispensing apparatus with prior art valve arrangements;

FIGS. 10a-10d illustrate cross sectional views of the valve arrangements in FIGS. 8 and 9 with the main flow control valve closed; with the main flow control valve open and the fluid pressure control valve closed; with the main flow control valve open and the fluid pressure control valve open allowing fluid flow from a central dispensing nozzle; and with the main flow control valve open and the fluid pressure control valve open allowing fluid flow from a peripheral dispensing nozzle or nozzles respectively.

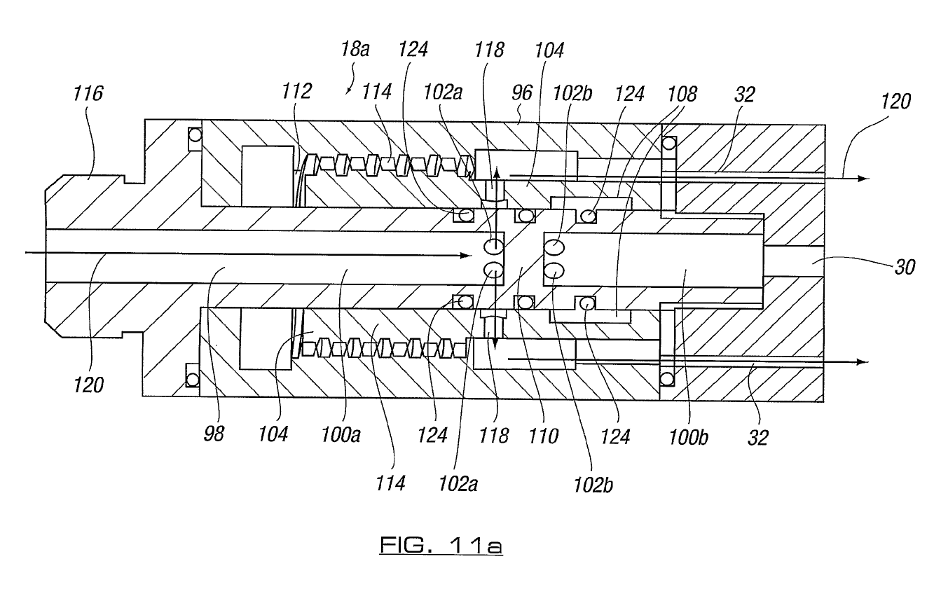

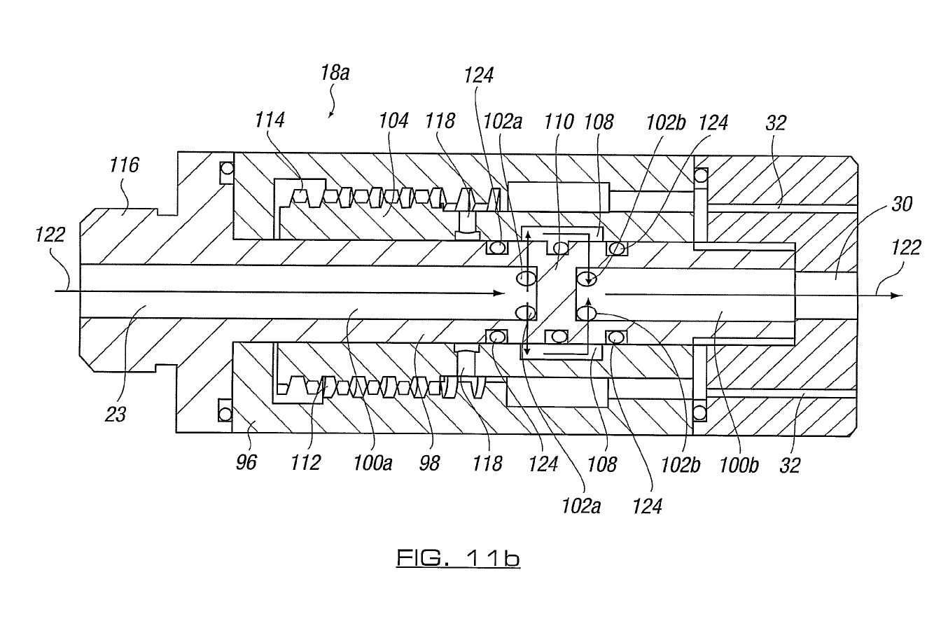

FIGS. 11a-11b show cross sectional views of a top portion of the dispensing apparatus in one embodiment of the present invention in first and second positions respectively.

Referring to the figures, there is illustrated toilet apparatus 2 including a toilet bowl 4 having a toilet seat 6 located on an upper edge of toilet bowl 4, a toilet lid 8 and a fluid reservoir in the form of a toilet cistern 10.

The toilet seat 6 and toilet lid 8 are typically hingedly mounted on toilet bowl 4 for moving relative to the toilet bowl in a conventional manner.

The toilet cistern 10 is connected to the toilet bowl via a conduit (not shown). When a user actuates a flush handle 12, water contained in cistern 10 passes along the conduit and into an upper portion of the toilet bowl 4. This flushing water acts to clear the toilet bowl after use via a siphon action and also has a partial cleaning effect as a result of the water passing over at least part of the surface of the toilet bowl. The water supplying the cistern 10 comes from a mains water supply via inlet conduit 14.

In accordance with an embodiment of the present invention there is provided dispensing apparatus in the form of a water dispenser 16. The water dispenser 16 includes an elongate body portion 18 having a first end 19 with fluid outlet means for allowing the ejection of water therefrom, user control means 20 provided on the body, and a second end 22 including fluid inlet means connected to a water conduit 24. The body portion can be ergonomically designed to increase the ease of a user handling the same.

Water conduit 24 is typically connected to mains water inlet conduit 14 via a valve arrangement 26. The valve arrangement allows the water supply to the water dispenser 16 to be moved between “on” and “off” conditions. Any suitable type of valve arrangement can be used and any suitable user actuation means can be provided with the valve arrangement to allow the valve to be moved between the on and off conditions. For example, a tap can be provided on the valve arrangement, a self cutting valve can be used and/or the like.

In one embodiment of the present invention, as shown in FIGS. 2a, 3-6, the first and second fluid outlet means at the first end 19 of the water dispenser 16 include a substantially flat or planar surface with a substantially central nozzle 30 (second fluid outlet means) and a plurality of nozzles 32 located around the peripheral edge thereof (first fluid outlet means). The nozzles 30, 32 are formed such that the central nozzle 30 allows a high pressure jet of water to be dispensed therefrom and the peripheral nozzles 32 allow lower pressure jets of water to be dispensed therefrom. It will be appreciated that the at least first and second fluid outlet nozzles can be provided in any suitable pattern or in any suitable arrangement.

A further arrangement of fluid outlet nozzles is shown in FIGS. 2b and 7 and will be described in more detail below.

The body portion 18 has a channel 23 passing through the interior thereof and a first end 25 of the channel communicates with the second and first fluid nozzles 30, 32 at first end 19 of the water dispenser, and a second end 27 of the channel communicates with the water conduit 24. As such, with the valve arrangement 26 in an “on” condition, water can pass from the mains water conduit 14, along conduit 24, through the channel 23 defined in body portion 18 and out through the nozzles 30, 32.

Control means 20 can be used to control the flow of water through the water dispenser 16 by opening and closing channel 23. Further control means can be used to adjust the pressure of the water flowing through the nozzles 30 or 32 and/or can be used to adjust which of the nozzles 30, 32 the water is dispensed from. For example, a user may only require water to be dispensed via the central nozzle 30.

In use of the device in FIG. 2a, once a user has finished with the toilet, if the user wishes to clean the interior surface 33 of the toilet bowl 4 in addition to the toilet flush, such as for example by directing the cleaning process towards one or more specific locations on the interior surface 33 of the toilet bowl as they would normally do conventionally with a toilet brush, the user grips the elongate body portion 18 in one hand and directs the nozzles 30, 32 towards the interior of the toilet bowl. The user then switches the water dispenser 16 to an “on” condition and water is ejected from nozzles 30 or 32. Control means 20 can be adjusted to provide the required level of water pressure from the nozzles necessary to provide a required level of cleaning in the toilet bowl. The force of the water against interior surface 33 helps to remove any marks or soiling of the toilet bowl. The user selected arbitrary and directed nature of the water dispensed from the water dispenser 16 provides a greater cleaning effect than a conventional flush and is significantly more hygienic than a conventional toilet brush, due to the dispenser not actually coming into direct contact with the interior surface of the toilet bowl in use.

The conduit 24 is typically of such a length to allow the elongate body 18 of the dispenser to be moved close to and preferably inside the toilet bowl 4. In addition, conduit 24 is typically substantially flexible to allow the dispenser to be easily manipulated and moved to any required angle relative to toilet bowl 4. This allows accurate cleaning to be undertaken.

It will be appreciated that in some types of toilet systems, the water dispenser can be used in place of a conventional toilet flush. However, in a preferred embodiment, the water dispenser is used in addition to the conventional toilet flush.

Support means in the form of a holder device 28 can be mounted on the wall adjacent the toilet for holding the water dispenser 16 in an “out of use” or storage position. The holder device 28 typically maintains the dispenser with the first end 19 uppermost to ensure that any residual water left in the body portion or conduit 24 after use does not spill out onto the floor surrounding the toilet. However, it will be appreciated that the holder device can be in any suitable form, such as a hook, clip, friction fit, inter-engaging member and/or the like and can hold the water dispenser in any suitable manner or orientation. In addition, to prevent further spillage of water or fluid from end 19, valve 51 blocks the flow of water when the water supply is turned off by valve 49.

The elongate body portion 18 can be provided in two parts; a top part 18a and an intermediate part 18b, the ends 34 of which are detachably attached together via a rotatable mounting in the form of a complementary screw thread arrangement 36. The two parts 18a, 18b can be separated via unscrewing of the screw thread arrangement. End 37 of intermediate part 18b is detachably attached via a rotatable mounting in the form of a complementary screw thread arrangement 36 to end 39 of base part 41, at least a part of base part 41 forms control means 20. Water inlet means 22 can also be detachably attached via a rotatable mounting in the form of a complementary screw thread arrangement to end 45 of base part 41 via end 43. Thus, the water dispensing head in the illustrated embodiment comprises four parts which are detachably attached to each other via rotatable mountings, thereby allowing easy dismantlement for cleaning and/or repair. It will be appreciated that fewer or greater number of parts can be provided to form the dispensing head if required.

One or more cleaning products, disinfectants, odourous products and/or the like can be inserted in or in association with the fluid channel 23 at any suitable location. The products can be easily inserted by unscrewing any suitable parts of the dispensing head and locating the product in channel 23.

In the illustrated embodiment, a cartridge 38 containing a disinfectant can be located in the channel 23, as shown by arrow 39 in FIG. 6, to allow disinfectant to be mixed with the fluid dispensed from dispenser 16. More particularly, cartridge 38 is located in a compartment defined in channel 23 in intermediate part 18b. Location means can be provided in the channel 23 in intermediate part 18b to allow the cartridge to be retained in position in use. Mesh 44 provided at opposite ends 46 of cartridge 38 allows water to pass through the cartridge from end to end as it flows through the channel 42. As water passes through the cartridge, at least part of the disinfectant dissolves in the fluid to produce a cleaning fluid for dispensing. The cartridge can be replaced as often as required in order to maintain a required concentration of cleaning product in the water.

The water dispenser can be formed from any suitable material, such as plastic, metal, rubber and/or the like. The dispenser can also be of any suitable size, shape and/or design. Preferably the dispenser is aesthetically pleasing and can be matched to any interior design within the bathroom or toilet in which it is to be located.

Gripping means in the form of knurled exterior surfaces 47 can be provided on top part 18a and base part 41 to allow a user to easily grip the exterior surface of the dispensing head. Gripping means could be provided at any suitable location and/or in any form on the dispensing means.

A flow control valve 49 is provided in base part 41 forming part of the control means for allowing control of the flow of fluid through dispensing head 16. A pressure valve 51 can be provided in top part 18a to allow control of the fluid pressure being dispensed from the dispensing head. Operation of the valves can be via rotation of one or more parts of the device in a suitable manner. Thus, for example, partial or a small amount of rotation of one or more of the parts may adjust the valve or valves.

FIG. 7 illustrates a further embodiment of top part 18a′ of dispensing head 16 in which a further outlet nozzle 53 is provided and outlet aperture 55 defined at an end of nozzle 53 typically protrudes in a different angle or direction to outlet nozzles 30, 32 to allow fluid to be dispensed at a different angle. In this illustrated embodiment nozzle 53 points in a substantially opposite direction to outlet nozzles 30, 32, thereby allowing water to be easily dispensed under a toilet rim of the toilet bowl 4, as shown by arrow 57 in FIG. 2b. Nozzles 30 and/or 32 may not be required in top part 18a′ and can be omitted.

Referring to FIGS. 8, 10a-10d, an exploded view of part of the water dispenser 16 is shown. A prior art flow control valve 49 for controlling the input of fluid into the dispensing apparatus includes a valve housing 60 which is of slightly smaller dimensions that the channel 23 defined in base part 41. Valve housing 60 has outwardly protruding location arms 62 at a first end 62 thereof to allow engagement with and location in corresponding recesses 64 defined in part 41. The valve housing 60 is fixed in place in the housing base part 41. Fluid apertures are defined in an outer wall of the valve housing. Circumferential grooves 67 are provided at spaced apart locations on the external surface of housing 60 and sealing washers 69 are located in said grooves 67 in use. The sealing washers prevent the flow of fluid past the same. The sealing washers 69 are located on the side of the fluid apertures closest to the fluid outlet means.

A valve closure element 66 is movably mounted in valve housing 60 via screw threads 68 which are complementary to screw thread portions provided on the interior walls of valve housing 60. The screw threads allow valve closure element 66 to be rotatably moved longitudinally of valve housing 60 and thus of base part 41. Thus, rotation of base part 41 with respect to housing part 18b causes closure element 66 to be rotated with respect to valve housing 60 between open and closed positions. Closure element 66 can move between ends 80 and 82 of valve housing 60 in a reciprocating manner when rotated.

End 76 of closure element 66 is attached to a valve seat component 74. When the valve 49 is in a closed position, the valve seat 74 engages with or in a channel defined in water inlet means 22, as shown in FIG. 10a, thereby preventing fluid from flowing past the valve seat towards the fluid outlet means. When the valve 49 is in an open position, the valve seat 74 is moved a spaced distance apart from the water inlet means 22, as shown in FIG. 10b, thereby allow fluid to flow past the valve seat towards the fluid outlet means.

When the valve 49 is in an open position, the valve seat 74 is moved a spaced distance apart from the water inlet means 22 and end 78 of the closure element 66 is moved towards end 82 of valve housing 60. Fluid flows through the water inlet means 22, around the external surface of end portion 80 of valve housing 60. The water is prevented from flowing towards opposite end 82 of valve housing 60 due to sealing washers 69. As such, the water passes through fluid apertures 65, into the interior channel of valve housing 60 and along the interior channel defined in base part 41.

When the valve 49 is in a closed position, the valve seat 74 engages with the water inlet means 22 and end 78 of closure element 66 is moved towards end 80 of valve housing 60. Water flows through water inlet means 22 but cannot pass valve seat 74.

Referring to FIGS. 9, 10a-10d, an exploded view of a top part 18a of a prior art water dispenser is shown. Prior art pressure valve 51 includes a valve housing 84 having a first end 86 which is larger in diameter than an opposite end 88, thereby providing a tapered shape to said valve 51 (i.e. the taper narrowing towards the fluid outlet end of the dispensing apparatus). The narrower end 88 faces towards the water outlet end of the dispensing apparatus and the wider end 86 faces towards the water inlet end of the dispensing apparatus. Fluid apertures 90 are defined adjacent the narrower end 88 of the valve housing 84. More particularly, fluid apertures 90a, 90b are arranged a spaced distance apart and longitudinally of the valve housing 84. Fluid flow through upper fluid aperture 90a allows fluid flow through central outlet nozzle 30 in use and fluid flow through lower fluid aperture 90b allows fluid flow through peripheral outlet nozzles 32 in use.

Location means in the form of a recess 85 is defined in the outer surface of valve housing 84 to allow valve housing to be rotated relative to a location housing 89 fitted in dispensing housing part 18b between open and closed positions. A protruding location arm 87 provided on location housing 89 is movable in location recess 85 to limit rotational and longitudinal movement between pre-defined limits. Sealing means in the form of sealing washers 69 prevent flow of fluid around the external surface of end 86 of valve 51. A valve seat 91 is defined on an interior surface of part 18a and the valve housing 84, and more particularly the fluid apertures 90a and 90b, are movable with respect to the valve seat 91 between open and closed positions.

When the flow control valve 49 is open, fluid flows through the channel defined in housing part 18b, through the interior of the channel defined at end 86 of valve housing 84 and flows to the exterior of valve housing 84 through either of apertures 90a, 90b.

With upper fluid aperture 90a located above valve seat 91 (i.e. the same side of valve seat 91 as outlet nozzle 30), as shown in FIG. 10c, fluid aperture 90b engages with valve seat 91, thereby preventing fluid flow through aperture 90b and directing all fluid flow through central outlet nozzle 30. Central outlet nozzle 30 typically communicates with fluid aperture 90a via a channel 92.

When the upper fluid aperture 90a is moved into engagement with valve seat 91, as shown in FIG. 10d, lower fluid aperture 90b is located below valve seat 91 (i.e. the opposite side of valve seat 91 to outlet nozzle 30), thereby preventing fluid flow through upper aperture 90a and directing allow fluid flow through peripheral outlet nozzles 32. Peripheral outlet nozzles 32 typically communicate with fluid aperture 90b via a channel 94.

The pressure control valve 51 is controlled by rotation of upper housing part 18a with respect to lower housing part 18b and/or the outlet nozzle housing part.

A problem with the above described prior art pressure valve is that a user is required to undertake a large degree of twisting of the two parts 18a and 18b relative to each other to allow water to flow through the central nozzle. This can result in a relatively large gap produced between the parts 18a and 18b which is aesthetically displeasing. In order to overcome this problem an alternative pressure valve or fluid flow control means is provided in accordance with the present invention as described with reference to FIGS. 11a and 11b.

Turning to FIGS. 11a and 11b, close-up cross-sectional views of the top part 18a of the water dispenser 16 are shown. In this embodiment the top part 18a has an outer dispensing apparatus housing 96 which may or may not have gripping means (not shown) located on an outer surface of the same, and channel means in the form of a substantially centrally located body element 98 defining a fluid channel 23 along a longitudinal axis of the same.

Body element 98 is divided into two separate channel portions, namely lower and upper chambers 100a, 100b divided by a partition 110. Thus chambers 100a and 100b are arranged in an end to end manner substantially along the longitudinal axis of the body element 98. Fluid flow directly between chambers 100a and 100b is prevented by partition 110.

The lower chamber 100a has a plurality of first fluid apertures 102a defined adjacent the partition 110. Apertures 102a are provided at approximately the same distance along the longitudinal axis of the body element. Upper chamber 100b has a plurality of second fluid apertures 102b adjacent the partition 110. Apertures 102b are provided at approximately the same distance along the longitudinal axis of the body element. Fluid flows between the lower and upper chambers 100a and 100b via passage means as will be described in more detail below.

Fluid flow control means in the form of a movable closure element 104 is provided between the outer housing 96 and the central body element. More particularly, closure element 104 is in the form of an elongate outer sleeve that is slidably or rotatably movable relative to the exterior surface of body element 98. A part of the inner surface of outer apparatus housing 96 has a screw thread portion 112 thereon which is substantially complementary to screw-thread portion 114 provided on an outer surface of closure element 104. This allows the closure element 104 to be rotatably moved relative to the body element 98 and the outer housing 96 between first and second positions. In the first position, fluid can flow from the channel of the body element, through the first apertures and through the first fluid outlet means or peripheral nozzles 32. In the second position, fluid can flow through from the channel of the body element, through the first and second apertures 102a, 102b and through the second fluid outlet means or central nozzle 30.

Closure element 104 has first and second fluid passages 118 and 108 defined therein. First fluid passage 118 is in the form of a channel located substantially perpendicular to the longitudinal axis of the closure element 104. Second fluid passage 108 is in the form of an elongate channel or recess located substantially parallel to the longitudinal axis of the closure element. First fluid passage 118 is located furthest from the fluid outlet means in this embodiment. Second fluid passage 108 is located a spaced distance apart from first passage 118 along the longitudinal axis of the closure element and is closer to the fluid outlet means.

Movement of the closure element relative to the dispensing housing and body element allows the first and second passages 118, 108 to be moved into substantial alignment with the first and second fluid outlet means of the dispensing housing and the apertures of the body element to allow selective fluid flow through the first and second fluid outlet means.

FIG. 11a shows the top part 18a of the dispensing apparatus in a first position, wherein fluid can flow through the dispensing apparatus and out through peripheral outlet nozzles 32. In the first position, first fluid passage 118 of the closure element is substantially aligned with first apertures 102a. Fluid flows through channel portion 100a, through first apertures 102a, through first passage 118 and through outlet nozzles 32. Since second passage way 108 is not aligned with the first apertures 102a, fluid flow is prevented through central nozzle 30 in the first position.

In use, fluid enters the top part 18a of the dispensing housing from the intermediate part 18b (not shown) via fluid channel 23.

Connecting portion 116 connects the top part 18a with the intermediate part 18b. Fluid enters first chamber 100a, passes through first fluid apertures 102a and into fluid passage 118 of the closure element. Fluid passage 118 communicates with peripheral outlet nozzles 32 via a suitable passage/conduit arrangement, thereby allowing the fluid to exit through the peripheral outlet nozzles 32. The direction of the fluid flow is indicated by arrows 120.

The closure element is movable from the first position to a second position, as shown in FIG. 11b, wherein fluid can now flow through central outlet nozzle 30. In the second position, fluid is prevented from flowing through the peripheral outlet nozzles 32. The closure element is moved away from outlet nozzle 30 when moving from the first position to the second position. This moves first fluid passage 118 out of alignment with fluid apertures 102a and an end of second fluid passage 108 into alignment with apertures 102a. The fluid passage 108 is elongate in form and, in one embodiment, runs substantially parallel to the longitudinal axis of the channel means 23. Thus, an opposite end of fluid passage 108 is brought into alignment with second apertures 102b. As such, fluid can now flow through first compartment 100a, through apertures 102a, passage 108, apertures 1026 and into second compartment 100b, as shown by arrows 122. Second compartment 100b is in fluid communication with central outlet nozzle 30 to allow dispensing of fluid therefrom in the second position.

Sealing means in the form of O-rings 124 and/or the like can be provided on either or both side of apertures 102a, 102b to prevent fluid from flowing between the closure element and the central portion.

The arrangement of the dispensing apparatus valve disclosed in FIGS. 11a and 11b can be combined with any or any combination of features described in the present application to form part of the present invention.

1. Dispensing apparatus, said dispensing apparatus including a housing having at least first and second fluid outlet means to allow fluid to flow out of said dispensing apparatus, channel means provided in said housing and having at least one aperture defined therein to allow fluid to flow from said channel means through either of said at least first and second fluid outlet means, said apparatus further including fluid flow control means for allowing selective control of the fluid flow from said channel means through said at least first or second fluid outlet means, characterized in that said fluid flow control means includes a closure element having passage means defined therein and said closure element is arranged to move relative to said channel means and/or said first and second fluid outlet means between a first position, wherein the passage means allows fluid communication between the at least one aperture of the channel means and the first fluid outlet means to allow fluid flow therethrough, and a second position, wherein the passage means allows fluid communication between the at least one aperture of the channel means and the second fluid outlet means to allow fluid flow therethrough.

2. Dispensing apparatus according to claim 1 characterized in that the closure element has first and second passage means defined therein; the first passage means allowing fluid communication between said at least one aperture of the channel means and the first fluid outlet means in the first position, and the second passage means allowing fluid communication between said at least one aperture of the channel means and the second fluid outlet means in the second position.

3. Dispensing apparatus according to claim 1 characterized in that with the closure element in the first position, fluid flow through said second fluid outlet means is substantially prevented and with the closure element in the second position, fluid flow through said first fluid outlet means is substantially prevented.

4. Dispensing apparatus according to claim 1 characterized in that the closure element is in the form of an outer sleeve located externally of said channel means in said housing and is movable relative to an external surface of said channel means.

5. Dispensing apparatus according to claim 1 characterized in that the channel means includes a body element with a channel defined therein and said body element is located in said housing.

6. Dispensing apparatus according to claim 5 characterized in that the channel defined in the body element includes a first channel portion, and a second channel portion with partition means separating said first and second channel portions to prevent direct fluid flow from said first channel portion to said second channel portions, at least one aperture being defined in said first channel portion and at least a further aperture being defined in said second channel portion, the passage means allowing fluid flow between the apertures of the first and second channel portions in the second position.

7. Dispensing apparatus according to claim 2 characterized in that the first passage means is arranged substantially transversally to the longitudinal axis of the closure element.

8. Dispensing apparatus according to claim 2 characterized in that the second passage means is arranged substantially parallel to the longitudinal axis of the closure element.

9. Dispensing apparatus according to claim 1 characterized in that the closure element is rotatably movable relative to said channel means and/or said housing.

10. Dispensing apparatus according to claim 9 characterized in that an outer surface of the closure element is provided with a screw thread arrangement which movably engages with a complementary screw thread arrangement provided on an inner surface of the housing of said apparatus.

11. Dispensing apparatus according to claim 1 characterized in that the first fluid outlet means is/are arranged adjacent a peripheral edge of an end of the dispensing apparatus and the second fluid outlet means are arranged substantially centrally of said end.

12. Dispensing apparatus according to any preceding claim characterized in that sealing means are provided on said closure element and/or an outer surface of said channel means between said first and second apertures of said channel means and/or said first and second passage means.

13. Dispensing apparatus according to claim 6 characterized in that a plurality of apertures are defined in each of said first and/or second channel portions.

14. Dispensing apparatus according to claim 1 characterized in that the passage means is substantially aligned with said at least one aperture and said first and second fluid outlet means in said first and second positions respectively.

15. A method of using dispensing apparatus, said dispensing apparatus including a housing having at least first and second fluid outlet means to allow fluid to flow out of said dispensing apparatus, channel means provided in said housing and having at least one aperture defined therein to allow fluid to flow from said channel means through either of said at least first and second fluid outlet means, said apparatus further including fluid flow control means for allowing selective control of the fluid flow from said channel means through said at least first or second fluid outlet means, said fluid flow control means including a closure element having passage means defined therein and said method includes the step of moving the closure element relative to said channel means and/or said first and second fluid outlet means between a first position, wherein the passage means allows fluid communication between the at least one aperture of the channel means and the first fluid outlet means to allow fluid flow therethrough, and a second position, wherein the passage means allows fluid communication between the at least one aperture of the channel means and the second fluid outlet means to allow fluid flow therethrough.
